(19) United States
(12) Patent Application Publication
(10) Pub. No.: US 2021/0335261 A1
(43) Pub. Date: Oct. 28, 2021

(54) PIXEL AND CONTROL METHOD THEREOF AND RELATED OLED DISPLAY

(71) Applicants: Bo YANG, Shenzhen (CN); Pengfei LIANG, Shenzhen (CN)

(72) Inventors: Bo YANG, Shenzhen (CN); Pengfei LIANG, Shenzhen (CN)

(21) Appl. No.: 16/625,052

(22) PCT Filed: Nov. 14, 2019
(86) PCT No.: PCT/CN2019/118480

§ 371 Date: Dec. 20, 2019

(30) Foreign Application Priority Data
Nov. 7, 2019 (CN) 201911079723.4

(51) Int. Cl. G09G 3/3258

(52) U.S. Cl. CPC G09G 3/3258; G09G 2320/043; G09G 2320/0233; G09G 2300/0852

(57) ABSTRACT

The present application provides a pixel and a control method thereof and a related OLED display. The present application could utilize the driving TFT having a main gate and a sub-gate and utilize the internal compensation to store the threshold voltage of the driving TFT into the second storage capacitor. In addition, the data voltage is applied to the first storage capacitor. The driving TFT is controlled by the main gate and the sub-gate to drive the light emitting unit to generate light. Because the threshold voltage of the second storage capacitor is applied to the driving TFT, the current flowing to the driving TFT and the threshold voltage are unrelated.

### FIELD OF THE INVENTION

The present invention relates to a display technique, and more particularly, to a pixel and a control method thereof and related organic light emitting diode (OLED) display.

### BACKGROUND

An active matrix OLED display comprises self-light-emitting OLEDs and also has some advantages of short response time, high light emitting efficiency, high luminance, and wide view angles. The OLED display arranges the pixels in a matrix. Each pixel comprises an OLED, a driving thin film transistor (TFT), a capacitor and a switch TFT. The driving TFT controls the driving current flowing into the OLED according to the voltage difference between the gate and the source. The capacitor is used to maintain the gate voltage of the driving TFT in a frame time. The switch TFT stores the data signal into the capacitor in response to the gate signal. The luminance of the pixel is proportional to the driving current of the OLED.

However, the OLED display has following disadvantages: due to manufacturing variances, the threshold voltage of the driving TFT may vary according to its location. Furthermore, as time goes by, the long driving time may deteriorate the electronic characters of the driving TFT such that the current characteristic curve of the driving TFT may shift. Therefore, the wanted luminance may not be obtained and the life time of the OLED display. Therefore, a solution is required to solve the above issues of uneven luminance and short life time of the OLED display caused by the difference and deterioration of the threshold voltage.

### SUMMARY

One objective of an embodiment of the present invention is to provide a pixel and a control method thereof and a related OLED display, to solve the above issues of uneven luminance and short life time of the OLED display caused by the difference and deterioration of the threshold voltage.

According to an embodiment of the present invention, a pixel is disclosed. The pixel comprises a light emitting unit, having an end electrically connected to a first common voltage end and another end electrically connected to a third node; a driving transistor, comprising a main gate, a sub-gate, a first end and a second end, wherein the main gate is electrically connected to a first node, the sub-gate is electrically connected to a second node, the first end is electrically connected to a second common voltage end, the second end is electrically connected to the third node, and the driving transistor has a threshold voltage; a first switch, having a control end electrically connected to a first scan signal input end, a first end electrically connected to a data line, and a second end electrically connected to the first node; a second switch, having a control end electrically connected to a second control signal input end, a first end electrically connected to a reference voltage input end, and a second end electrically connected to the second node; a third switch, having a control end electrically connected to a third control signal input end, a first end electrically connected to a predetermined voltage input end, and a second end electrically connected to the third node; a first storage capacitor, having a first end electrically connected to the first node and a second end electrically connected to the third node; and a second storage capacitor, having a first end electrically connected to the second node and a second end electrically connected to the third node.

In the pixel, the reference voltage input end is electrically connected to the data line.

In the pixel, the pixel further comprises a signal supplying line, having an end electrically connected to a select switch. The first end of the third switch is electrically connected to the signal supplying line, and the predetermined end writes a predetermined voltage into the third node when the select switch selects the predetermined voltage input end.

In the pixel, the pixel further comprises an electron mobility detection end, electrically connected to an electron mobility detecting unit. The electron mobility detection end loads a detection signal and collects a voltage of the third node when the select switch selects the electron mobility detection end. The electron mobility detecting unit calculates an electron mobility of the driving transistor according to the voltage of the third node detected by the electron mobility detection end.

In the pixel, the select switch functions as a single pole double throw switch.

In the pixel, the second control signal input end is configured to load a second scan signal and the third control signal input end is configured to load a third scan signal.

In the pixel, a voltage loaded by the second common voltage end is higher than a voltage loaded by the first common voltage end.

In the pixel, the light emitting unit is an organic light emitting diode.

According to an embodiment of the present invention, a control method of above-mentioned pixel is disclosed. When driving the above pixel, the control method comprises: in a threshold voltage obtaining stage, the first switch is turned off, the second switch is tuned on to write the reference voltage into the second node, the third switch is turned on to write the first predetermined voltage into the third node such that that a voltage of the third node gradually rises to make a voltage difference between the third node and the second node the threshold voltage, and the second storage capacitor obtains the threshold voltage; in a data voltage writing stage, the second switch is turned off, the first switch is turned on to write the data voltage transferred from the data line into the first node, the third switch is turned on to write a second predetermined voltage into the third node, and the first storage capacitor obtains a voltage difference between the data voltage and the second predetermined voltage; and in a light emitting stage, the first switch, the second switch, and the third switch are tuned off, and the driving transistor is turned on to drive the light emitting unit to generate light.

The pixel further comprises a signal supplying line electrically connected to the first end of the third switch and an electron detection end electrically connected an electron mobility detecting unit, one end of the signal supplying line is electrically connected to a select switch, the electron mobility detecting unit calculates an electron mobility according to a voltage of the third node detected by the electron mobility detection end, and the method further comprises the following steps to detect the electronic mobility of the driving transistor:

in a threshold voltage obtaining stage, the first switch is turned off, the second switch is turned on to write the reference voltage into the second node, the third switched is turned on to write a third predetermined voltage into the third node, the voltage of the third node gradually rises to make a voltage difference between the third node and the second node the threshold voltage, and the second storage capacitor obtains the threshold voltage; and

in an electron mobility obtaining stage, the second switch is turned off, the first switch is turned on to write the second reference voltage into the first node, the third switch is turned on to write a fourth predetermined voltage into the third node and then is turned off, the first storage capacitor obtains a voltage difference between the second reference voltage and the fourth predetermined voltage as a data voltage corresponding to an electron mobility, the driving transistor is turned on by voltages of the main gate and the sub-gate, the select switch selects the electron mobility detection end such that the electron mobility detection end loads a detection signal to the signal supplying line and collects the voltage of the third node to the electron mobility detection end.

According to an embodiment of the present invention, an organic light emitting diode (OLED) display. The OLED display includes a pixel. The pixel comprises a light emitting unit, having an end electrically connected to a first common voltage end and another end electrically connected to a third node; a driving transistor, comprising a main gate, a sub-gate, a first end and a second end, wherein the main gate is electrically connected to a first node, the sub-gate is electrically connected to a second node, the first end is electrically connected to a second common voltage end, the second end is electrically connected to the third node, and the driving transistor has a threshold voltage; a first switch, having a control end electrically connected to a first scan signal input end, a first end electrically connected to a data line, and a second end electrically connected to the first node; a second switch, having a control end electrically connected to a second control signal input end, a first end electrically connected to a reference voltage input end, and a second end electrically connected to the second node; a third switch, having a control end electrically connected to a third control signal input end, a first end electrically connected to a predetermined voltage input end, and a second end electrically connected to the third node; a first storage capacitor, having a first end electrically connected to the first node and a second end electrically connected to the third node; and a second storage capacitor, having a first end electrically connected to the second node and a second end electrically connected to the third node.

In the OLED display, the reference voltage input end is electrically connected to the data line.

In the OLED display, the pixel further comprises a signal supplying line, having an end electrically connected to a select switch. The first end of the third switch is electrically connected to the signal supplying line, and the predetermined end writes a predetermined voltage into the third node when the select switch selects the predetermined voltage input end.

In the OLED display, the pixel further comprises an electron mobility detection end, electrically connected to an electron mobility detecting unit. The electron mobility detection end loads a detection signal and collects a voltage of the third node when the select switch selects the electron mobility detection end. The electron mobility detecting unit calculates an electron mobility of the driving transistor according to the voltage of the third node detected by the electron mobility detection end.

In the OLED display, the select switch functions as a single pole double throw switch.

In the OLED display, the second control signal input end is configured to load a second scan signal and the third control signal input end is configured to load a third scan signal.

In the OLED display, a voltage loaded by the second common voltage end is higher than a voltage loaded by the first common voltage end.

In the OLED display, the light emitting unit is an organic light emitting diode.

The present application provides a pixel and a control method thereof and a related OLED display. The present application could utilize the driving TFT having a main gate and a sub-gate and utilize the internal compensation to store the threshold voltage of the driving TFT into the second storage capacitor. In addition, the data voltage is applied to the first storage capacitor. The driving TFT is controlled by the main gate and the sub-gate to drive the light emitting unit to generate light. Because the threshold voltage of the second storage capacitor is applied to the driving TFT, the current flowing to the driving TFT and the threshold voltage are unrelated. This raises the evenness of the displayed image of the OLED display panel and its life time. Furthermore, in contrast to the conventional art, which needs more time to obtain the compensation voltage due to the external compensation mechanism, the present application could shorten the compensation voltage detection and the process time for data feedback.

In addition, the main gate and the sub-gate share the same data line. This raises the aperture rate of the OLED display.

Furthermore, the pixel could detect the electron mobility of the driving TFT to compensate the data voltage according to the detected electron mobility. This achieves the compensation according to the electron mobility. That is, the electron mobility of the driving TFT is externally detected to achieve the external compensation according to the electron mobility.

### BRIEF DESCRIPTION OF THE DRAWINGS

FIG. 1 is a diagram of a pixel structure according to an embodiment of the present invention.

FIG. 2 is a timing diagram of waveforms for driving the pixel shown in FIG. 1.

FIG. 3 is a diagram of a pixel structure according to another embodiment of the present invention.

FIG. 4 is a timing diagram of waveforms of the electron mobility of the driving TFT in the pixel shown in FIG. 3.

### DETAILED DESCRIPTION OF PREFERRED EMBODIMENTS

The invention is described below in detail with reference to the accompanying drawings, wherein like reference numerals are used to identify like elements illustrated in one or more of the figures thereof, and in which exemplary embodiments of the invention are shown. This invention may, however, be embodied in many different forms and should not be construed as limited to the particular embodiments set forth herein. Rather, these embodiments are provided so that this disclosure will be thorough and complete, and will fully convey the scope of the invention to those skilled in the art.

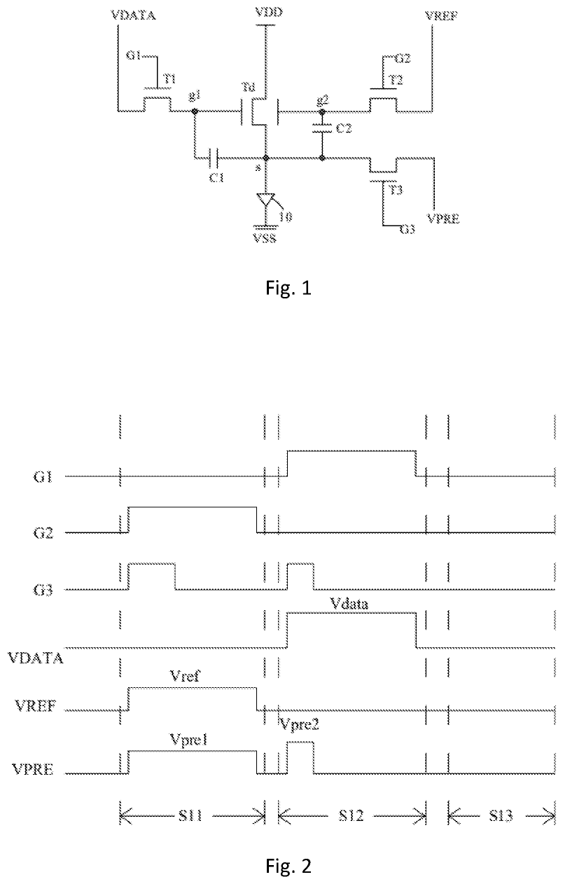

Please refer to FIG. 1. FIG. 1 is a diagram of a pixel structure according to an embodiment of the present invention. The pixel comprises a light emitting unit 10, a driving transistor Td, a first switch T1, a second switch T2, a third switch T3, a first storage capacitor C1 and a second storage capacitor C2.

The light emitting unit 10 is driven by the driving transistor Td to generate light to display images. The light emitting unit 10 is an organic light emitting diode (OLED). One end of the light emitting unit 10 is electrically connected to the common voltage end Vss and the other end of the light emitting unit 10 is electrically connected to the third node s. The first common voltage end VSS is a ground end.

The driving transistor Td has a main gate, a sub-gate, a first end and a second end. The main gate is electrically connected to a first node g1. The sub-gate is electrically connected to a second node g2. The first end is electrically connected to a second common voltage end VDD. The second end is electrically connected to the third node s. The driving transistor Td has a threshold voltage Vth. The second common voltage end VDD is a voltage source end. The voltage loaded at the second common voltage end VDD is higher than the voltage loaded at the first common voltage end VSS. The voltage stored in the first storage capacitor C1 is applied to the main gate of the driving transistor Td, the voltage stored in the second storage capacitor C2 is applied to the sub-gate of the driving transistor Td and the second common voltage end VDD is inputted to the first end of the driving transistor Td. With the above three voltages, the driving transistor Td is tuned on to drive the light emitting unit 10 to generate light. The first switch T1 has a control end, a first end and a second end. The control end of the first switch T1 is electrically connected to the first scan signal input end G1, the first end of the first switch T1 is electrically connected to the data line VDATA, and the second end of the first switch T1 is electrically connected to the first node g1. The first scan signal inputted from first scan signal input end G1 turns on the first switch T1 such that the data voltage Vdata loaded by the first end of the first switch T1 is written into the main gate of the driving transistor Td.

The second switch T2 has a control end, a first end and a second end. The control end of the second switch T2 is electrically connected to the second control signal input end G2. The first end of the second switch T2 is electrically connected to the voltage input end VREF. The second end of the second switch T2 is electrically connected to the second node g2. The second switch T2 is turned on by the second control signal inputted from the second control signal input end G2 such that the reference voltage Vref inputted from the reference voltage input end VREF is applied to the sub-gate. If the voltage difference between the reference voltage Vref of the second node g2 and the voltage of the third node s is equal to the threshold voltage Vth of the driving transistor Td, then the driving transistor is turned off and the second storage capacitor C2 obtains the threshold voltage Vth of the driving transistor Td. If the voltage difference between the reference voltage Vref of the second node g2 and the voltage of the third node s is larger than the threshold voltage Vth of the driving transistor Td, then the driving transistor Td is turned on and thus the second common voltage end VDD charges the third node s such that the voltage of the third node s rises to make the voltage difference between the second node g2 and the third node s the same as the threshold voltage Vth of the driving transistor Td. That is, the voltage of the third node s rises to Vref-Vth. The second storage capacitor C2 obtains the threshold value Vth of the driving transistor Td.

The third switch T3 has a control end, a first end and a second end. The control end of the third switch T3 is electrically connected to the third control signal input end G3. The first end of the third switch T3 is electrically connected to the predetermined voltage input end VPRE. The second end of the third switch T3 is electrically connected to the third node s. The third switch T3 is used to write the predetermined voltage Vref1 into the third node s in the threshold voltage obtaining stage and is turned off after the first predetermined voltage Vref1 is written into the third node s. The first predetermined voltage Vpre1 is less than or equal to the reference voltage Vref inputted from the reference voltage input end VREF. The third switch T3 is further used to write the second predetermined voltage Vpre2 into the third node s in the data voltage writing stage and is turned off after the second predetermined voltage Vpre2 is written into the third node s.

The first end of the first storage capacitor C1 is electrically connected to the first node g1. The second end of the first storage capacitor C1 is electrically connected to the third node s. The first storage capacitor C1 is used to store the voltage difference between the data voltage Vdata at the first node g1 and the second predetermined voltage Vpre2 at the third node s in the data voltage writing stage.

The first end of the second storage capacitor C2 is electrically connected to the second node G2. The second end of the second storage capacitor C2 is electrically connected to the third node s. The second storage capacitor C2 is used to store the threshold voltage Vth of the driving transistor Td in the threshold voltage obtaining stage.

The driving transistor Td, the first switch T1, the second switch T2 and the third switch T3 could be thin film field effect transistors (TFT) or other electronic devices that could be used as switches. The present invention does not put any limitations on it. In this embodiment, the first switch T1, the second switch T2 and the third switch T3 are all n-type TFTs. A high voltage level is applied to the main gate and the sub-gate of the driving transistor Td to turn on the driving transistor Td. In this embodiment, the first end of the switch is a drain of the switch and the second end of the switch is a source of switch. This is not a limitation of the present invention. In the actual implementation, the source and the drain could be switched.

In this embodiment, the second control signal input end G2 is used to load the second scan signal. The third control signal input end G3 is used to load the third scan signal.

Please refer to FIG. 2. FIG. 2 is a timing diagram of waveforms for driving the pixel shown in FIG. 1. The driving process of the pixel comprises the threshold voltage obtaining stage, the data voltage writing stage and the lighting emitting stage. In the following disclosure, the above three stages will be illustrated in details.

In the threshold voltage obtaining stage S11, the low voltage level is inputted to the first scan signal input end G1 and the first switch T1 is turned off. The high voltage signal is inputted to the second control signal input end G2 and the second switch T2 is turned on. The reference voltage Vref is inputted to the second node g2 from the reference voltage input end VREF. A high voltage level is inputted to the third control signal input end G3 and the third switch T3 is turned on. After the first predetermined voltage Vpre1 inputted from the predetermined voltage input end VPRE is written into the third node s, the third switch T3 is turned off. If the voltage difference between the reference voltage Vref and the first predetermined voltage Vpre1 is equal to the threshold voltage Vth, then the second storage capacitor C2 obtains the threshold voltage Vth. If the voltage difference between the reference voltage Vref and the first predetermined voltage Vpre1 is larger than the threshold voltage Vth, then the driving transistor Td is turned on and the second common voltage VDD charges the third node s such that the voltage of the third node s rises to make the voltage difference between the second node g2 and the third node s equal to the threshold voltage Vth of the driving transistor Td. The second storage capacitor C2 obtains the threshold value Vth of the driving transistor Td. That is, the threshold voltage Vth is stored in the second storage capacitor C2.

In the data voltage writing stage S12, a high voltage level is inputted to the first scan signal input end and the first switch T1 is turned on such that the data voltage Vdata is written into the first node g1 from the data line VDATA. A low voltage level is inputted to the second control signal input G2 and the second switch T2 is turned off. A high voltage level is inputted to the third control signal input end G3 and the third switch T3 is turned on to write the second predetermined voltage Vpre2 to the third node s. After the second predetermined voltage Vpre2 is written to the third node s, the third switch T3 is turned off. The first storage capacitor C1 obtains the voltage difference between the data voltage Vdata and the second predetermined voltage Vpre2. That is, the difference between the data voltage Vdata and the second predetermined voltage Vpre2 is stored in the first storage capacitor and the data voltage Vdata is larger than the second predetermined voltage Vpre2.

In the light emitting stage S13, a low voltage level is inputted to the first scan signal input end G1 and the first switch T1 is turned off. A low voltage level is inputted into the second control signal input end G2 and the second switch T2 is turned off. A low voltage level is inputted to the third control signal input end G3 and the third switch T3 is turned off. The driving transistor Td is turned on by the first storage capacitor C1 and the second storage capacitor C2 such that the voltage inputted from the second common voltage end VDD is written to the third node s. In this way, the current flows through the light emitting unit 10 and thus the light emitting unit 10 generates light.

Because the second storage capacitor C2 applies the threshold voltage Vth to the driving transistor Td such that the current flowing through the driving transistor Td and the threshold voltage of the driving transistor Td are unrelated. This raises the evenness of the display image of the OLED display and also raises the life time of the OLED display.

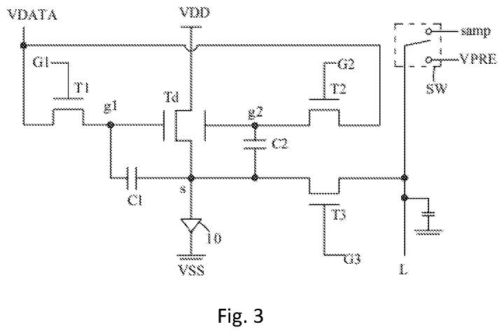

Please refer to FIG. 3. FIG. 3 is a diagram of a pixel structure according to another embodiment of the present invention. The pixel shown in FIG. 3 is similar to the pixel shown in FIG. 1. The difference between them is: the reference voltage input end VREF is electrically connected to the data line VDATA.

The pixel further comprises a signal supplying line L. The first end of the third switch T3 is electrically connected to the signal supplying line L. One end of the signal supplying line L is electrically connected to the select switch SW. The select switch SW is a single pole double throw switch. When the select switch SW selects the predetermined voltage input end VPRE, the predetermined voltage input end VPRE writes the predetermined voltage, which may comprise the first predetermined voltage Vref1 and the second predetermined voltage Vref2, to the third node s.

The pixel further comprises the electron mobility detection end samp, electrically connected to the electron mobility detecting unit (not shown). When the select switch SW selects the electron mobility detection end samp, the electron mobility detection end samp loads the detection signal and collects the voltage Vs of the third node s. The electron mobility detection unit is used to calculate the electron mobility of the driving transistor Td according to the voltage Vs of the third node s detected by the electron mobility detection end samp.

The electron mobility detecting unit calculates the electron mobility k of the driving transistor according to the formula loled=K(Vg1−Vs)2. Here, loled is the current flowing through the light emitting unit 10. Vs is the voltage of the third node s detected by the electron mobility detection end samp. Vg1 is the data voltage Vdata inputted form the data line VDATA. loled could be obtained by detecting the current at the third node s.

In contrast to the pixel shown in FIG. 1, in this embodiment, the pixel could reduce the number of conducting lines and raise the aperture rate through connecting the reference voltage input end VREF to the data line VDATA. In addition, the pixel could detect the electron mobility of the driving transistor Td through including the select switch SW and the electron mobility detection end. In this way, the pixel could compensate the data voltage according to the detected electron mobility to achieve the compensation of the driving transistor according to the electron mobility. That is, the electron mobility could be externally detected to achieve an external compensation of compensation of the driving transistor according to the electron mobility.

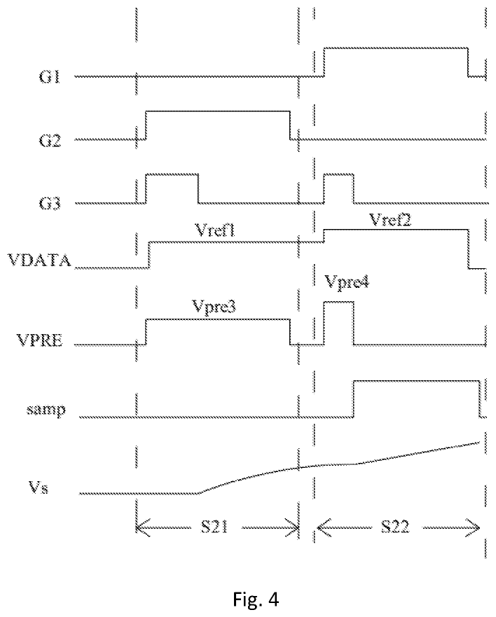

Please refer to FIG. 4. FIG. 4 is a timing diagram of waveforms of the electron mobility of the driving TFT in the pixel shown in FIG. 3. The detection of the electron mobility of the driving transistor comprises two stages: the threshold voltage obtaining stage and the electron mobility obtaining stage.

In the threshold voltage obtaining stage S21, a low voltage signal is inputted to the first scan signal input end G1 and the first switch is turned off. A high voltage level is inputted to the second signal input end G2 and the second switch is turned on to write the first reference voltage Vref loaded by the data line VDATA into the second node g2. A high voltage level is inputted to the third control signal end G3 and the select switch SW selects the predetermined voltage input end VPRE such that the third predetermined voltage Vpre3 loaded by the predetermined voltage input end VPRE is written into the third node s. If the voltage difference between the first reference voltage Fref1 and the third predetermined voltage Vpre3 is the threshold voltage Vth of the driving transistor Td, then the second storage capacitor C2 stores the threshold voltage Vth. If the voltage difference between the first reference voltage Vref1 and the third predetermined voltage Vpre3 is is larger than the threshold voltage Vth of the driving transistor Td, then the driving transistor Td is turned on and thus the second common voltage end VDD charges the third node s such that the voltage of the third node s rises to make the voltage difference between the second node g2 and the third node s the same as the threshold voltage Vth of the driving transistor Td. The second storage capacitor C2 obtains the threshold value Vth.

In the electron mobility obtaining stage S22, a low voltage level is inputted to the second control signal input end G2 and the second switch T2 is turned off. A high voltage level is inputted to the first scan signal input end G1 and the first switch T1 is turned on to write the second reference voltage Vref2 to the first node g1. A high voltage level is inputted to the third control signal input end G3 and the third switch T3 is turned on to write the fourth predetermined voltage Vpre4 inputted from the predetermined voltage end VPRE to the third node s. After the fourth predetermined voltage Vpre4 is written to the third node s, the third switch T3 is turned off. The first storage capacitor C1 obtains the voltage difference Vref2−Vref4 between the second reference voltage Vref2 and the fourth reference voltage Vref4, which is used as a data voltage corresponding to the electron mobility. The driving transistor Td is turned on by the main gate and the sub-gate. The select switch SW selects the electron mobility detection end samp. The electron mobility detection end samp loads the detection signal from the signal supplying line L and obtains the voltage Vs of the third node s.

The electron mobility detection end samp is electrically connected to the electron mobility detecting unit. The electron mobility detecting unit calculates the electron mobility of the driving transistor Td according to the voltage of the third node s detected by the electron mobility detection end samp. The calculation method of the electron mobility had been illustrated in the above and is thus omitted here.

The driving process of the pixel is performed when the OLED display needs to display images. The detection of the electron mobility of the driving transistor is performed when the OLED display does not need to display images. Through detecting the electron mobility of the driving transistor, the data voltage could be adjusted when the pixels need to display images to compensate the electron mobility and thus achieve the external compensation of the driving transistor according to the electron mobility. This benefits the following external compensation for the electron mobility. In addition, the pixel shown in FIG. 3 could not only detect the electron mobility of the driving transistor, but also perform the driving process of the pixel shown in FIG. 1.

In addition, the present application further provides an OLED display comprising the above-mentioned pixel.

The present application provides a pixel and a control method thereof and a related OLED display. The present application could utilize the driving TFT having a main gate and a sub-gate and utilize the internal compensation to store the threshold voltage of the driving TFT into the second storage capacitor. In addition, the data voltage is applied to the first storage capacitor. The driving TFT is controlled by the main gate and the sub-gate to drive the light emitting unit to generate light. Because the threshold voltage of the second storage capacitor is applied to the driving TFT, the current flowing to the driving TFT and the threshold voltage are unrelated. This raises the evenness of the displayed image of the OLED display panel and its life time.

Above are embodiments of the present invention, which does not limit the scope of the present invention. Any modifications, equivalent replacements or improvements within the spirit and principles of the embodiment described above should be covered by the protected scope of the invention.

What is claimed is:

1. A pixel, comprising:
a light emitting unit, having an end electrically connected to a first common voltage end and another end electrically connected to a third node;
a driving transistor, comprising a main gate, a sub-gate, a first end and a second end, wherein the main gate is electrically connected to a first node, the sub-gate is electrically connected to a second node, the first end is electrically connected to a second common voltage end, the second end is electrically connected to the third node, and the driving transistor has a threshold voltage;
a first switch, having a control end electrically connected to a first scan signal input end, a first end electrically connected to a data line, and a second end electrically connected to the first node;
a second switch, having a control end electrically connected to a second control signal input end, a first end electrically connected to a reference voltage input end, and a second end electrically connected to the second node;
a third switch, having a control end electrically connected to a third control signal input end, a first end electrically connected to a predetermined voltage input end, and a second end electrically connected to the third node;
a first storage capacitor, having a first end electrically connected to the first node and a second end electrically connected to the third node; and
a second storage capacitor, having a first end electrically connected to the second node and a second end electrically connected to the third node.

2. The pixel of claim 1, wherein the reference voltage input end is electrically connected to the data line.

3. The pixel of claim 1, further comprising:
a signal supplying line, having an end electrically connected to a select switch;
wherein the first end of the third switch is electrically connected to the signal supplying line, and the predetermined end writes a predetermined voltage into the third node when the select switch selects the predetermined voltage input end.

4. The pixel of claim 3, further comprising:
an electron mobility detection end, electrically connected to an electron mobility detecting unit;
wherein the electron mobility detection end loads a detection signal and collects a voltage of the third node when the select switch selects the electron mobility detection end; and
wherein the electron mobility detecting unit calculates an electron mobility of the driving transistor according to the voltage of the third node detected by the electron mobility detection end.

5. The pixel of claim 3, wherein the select switch functions as a single pole double throw switch.

6. The pixel of claim 1, wherein the second control signal input end is configured to load a second scan signal and the third control signal input end is configured to load a third scan signal.

7. The pixel of claim 1, wherein a voltage loaded by the second common voltage end is higher than a voltage loaded by the first common voltage end.

8. The pixel of claim 1, wherein the light emitting unit is an organic light emitting diode.

9. A control method of a pixel of claim 1, the method comprising following steps to drive the pixel:
in a threshold voltage obtaining stage, the first switch is turned off, the second switch is tuned on to write the reference voltage into the second node, the third switch is turned on to write the first predetermined voltage into the third node such that that a voltage of the third node gradually rises to make a voltage difference between the third node and the second node the threshold voltage, and the second storage capacitor obtains the threshold voltage;
in a data voltage writing stage, the second switch is turned off, the first switch is turned on to write the data voltage transferred from the data line into the first node, the third switch is turned on to write a second predetermined voltage into the third node, and the first storage capacitor obtains a voltage difference between the data voltage and the second predetermined voltage; and
in a light emitting stage, the first switch, the second switch, and the third switch are tuned off, and the driving transistor is turned on to drive the light emitting unit to generate light.

10. The control method of claim 9, wherein the pixel further comprises a signal supplying line electrically connected to the first end of the third switch and an electron detection end electrically connected an electron mobility detecting unit, one end of the signal supplying line is electrically connected to a select switch, the electron mobility detecting unit calculates an electron mobility according to a voltage of the third node detected by the electron mobility detection end, and the method further comprises the following steps to detect the electronic mobility of the driving transistor:
in a threshold voltage obtaining stage, the first switch is turned off, the second switch is turned on to write the reference voltage into the second node, the third switched is turned on to write a third predetermined voltage into the third node, the voltage of the third node gradually rises to make a voltage difference between the third node and the second node the threshold voltage, and the second storage capacitor obtains the threshold voltage; and
in an electron mobility obtaining stage, the second switch is turned off, the first switch is turned on to write the second reference voltage into the first node, the third switch is turned on to write a fourth predetermined voltage into the third node and then is turned off, the first storage capacitor obtains a voltage difference between the second reference voltage and the fourth predetermined voltage as a data voltage corresponding to an electron mobility, the driving transistor is turned on by voltages of the main gate and the sub-gate, the select switch selects the electron mobility detection end such that the electron mobility detection end loads a detection signal to the signal supplying line and collects the voltage of the third node to the electron mobility detection end.

11. An organic light emitting diode (OLED) display comprising a pixel, the pixel comprising:
a light emitting unit, having an end electrically connected to a first common voltage end and another end electrically connected to a third node;
a driving transistor, comprising a main gate, a sub-gate, a first end and a second end, wherein the main gate is electrically connected to a first node, the sub-gate is electrically connected to a second node, the first end is electrically connected to a second common voltage end, the second end is electrically connected to the third node, and the driving transistor has a threshold voltage;
a first switch, having a control end electrically connected to a first scan signal input end, a first end electrically connected to a data line, and a second end electrically connected to the first node;
a second switch, having a control end electrically connected to a second control signal input end, a first end electrically connected to a reference voltage input end, and a second end electrically connected to the second node;
a third switch, having a control end electrically connected to a third control signal input end, a first end electrically connected to a predetermined voltage input end, and a second end electrically connected to the third node;
a first storage capacitor, having a first end electrically connected to the first node and a second end electrically connected to the third node; and
a second storage capacitor, having a first end electrically connected to the second node and a second end electrically connected to the third node.

12. The OLED display of claim 11, wherein the reference voltage input end is electrically connected to the data line.

13. The OLED display of claim 11, wherein the pixel further comprises:
a signal supplying line, having an end electrically connected to a select switch;
wherein the first end of the third switch is electrically connected to the signal supplying line, and the predetermined end writes a predetermined voltage into the third node when the select switch selects the predetermined voltage input end.

14. The OLED display of claim 13, wherein the pixel further comprises:
an electron mobility detection end, electrically connected to an electron mobility detecting unit;
wherein the electron mobility detection end loads a detection signal and collects a voltage of the third node when the select switch selects the electron mobility detection end; and
wherein the electron mobility detecting unit calculates an electron mobility of the driving transistor according to the voltage of the third node detected by the electron mobility detection end.

15. The OLED display of claim 13, wherein the select switch functions as a single pole double throw switch.

16. The OLED display of claim 11, wherein the second control signal input end is configured to load a second scan signal and the third control signal input end is configured to load a third scan signal.

17. The OLED display of claim 11, wherein a voltage loaded by the second common voltage end is higher than a voltage loaded by the first common voltage end.

18. The OLED display of claim 11, wherein the light emitting unit is an organic light emitting diode.
